(19) United States
(12) Patent Application Publication
(10) Pub. No.: US 2025/0119830 A1
(43) Pub. Date: Apr. 10, 2025

(54) MULTI-LINK COMMUNICATION OF TWT INFORMATION FOR MULTI-LINK OPERATION

(71) Applicant: Samsung Electronics Co., Ltd., Suwon-si (KR)

(72) Inventors: Rubayet Shafin, Allen, TX (US); Boon Loong Ng, Plano, TX (US); Vishnu Vardhan Ratnam, Plano, TX (US); Peshal Nayak, Plano, TX (US); Yue Qi, Plano, TX (US)

(21) Appl. No.: 18/896,749

(22) Filed: Sep. 25, 2024

Related U.S. Application Data
(60) Provisional application No. 63/543,224, filed on Oct. 9, 2023.

(51) Int. Cl. H04W 52/02; H04W 76/15; H04W 84/12

(52) U.S. Cl. CPC H04W 52/0216; H04W 76/15; H04W 84/12

(57) ABSTRACT

A non-access point multi-link device (non-AP MLD) in a wireless network, the non-AP MLD comprising a memory and a processor coupled to the memory, the processor configured to establish a first link between a first station (STA) affiliated with the non-AP MLD and a first AP affiliated with an AP MLD, establish a second link between a second STA affiliated with the non-AP MLD and a second AP affiliated with the AP MLD, establish a target-wake-time (TWT) agreement or a TWT schedule on the first link between the first STA and the first AP, and transmit, from the first STA to the first AP on the first link, a frame intended for the second AP operating on the second link, wherein the frame includes information regarding when the TWT agreement or the TWT schedule established on the second link is suspended.

### CROSS-REFERENCE TO RELATED APPLICATION(S)

This application claims the benefit of priority from U.S. Provisional Application No. 63/543,224, entitled “ENHANCEMENT FOR TWT INFORMATION USAGE FOR MLO” filed Oct. 9, 2023, which is incorporated herein by reference in its entirety.

### TECHNICAL FIELD

This disclosure relates generally to a wireless communication system, and more particularly to, for example, but not limited to, multi-link communication of target wake time (TWT) information for multi-link operation (MLO).

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a non-access point (AP) multi-link device (MLD) in a wireless network. The non-AP MLD comprises a memory, and a processor coupled to the memory. The processor is configured to establish a first link between a first station (STA) affiliated with the non-AP MLD and a first AP affiliated with an AP MLD. The processor is configured to establish a second link between a second STA affiliated with the non-AP MLD and a second AP affiliated with the AP MLD. The processor is configured to establish a target-wake-time (TWT) agreement or a TWT schedule on the first link between the first STA and the first AP. The processor is configured to transmit, from the first STA to the first AP on the first link, a frame intended for the second AP operating on the second link, wherein the frame includes information regarding when the TWT agreement or the TWT schedule established on the second link is suspended.

In some embodiments, the frame indicates a starting service period (SP) from which the TWT agreement or the TWT schedule on the second link is suspended.

In some embodiments, the frame indicates a time after which the TWT agreement or the TWT schedule on the second link is suspended.

In some embodiments, the frame includes a TWT requesting STA media access control (MAC) address and a TWT responding STA MAC address, wherein the TWT requesting MAC address is a TWT requesting STA MAC address corresponding to the second link indicated in the frame and the TWT responding STA MAC address is a TWT responding STA MAC address corresponding to the second link indicated in the frame.

In some embodiments, the frame includes information regarding when all TWT agreements or TWT schedules between the non-AP MLD and the AP MLD are suspended, wherein the processor is further configured to suspend, based on the information regarding when all the TWT agreements or TWT schedules are suspended, all TWT agreements or TWT schedules between the non-AP MLD and the AP MLD.

In some embodiments, the processor is further configured to transmit, from the first STA to the first AP on the first link, a second frame intended for the second AP operating on the second link, wherein the second frame includes information regarding when the TWT agreement or the TWT schedule on the second link is resumed.

In some embodiments, the second frame includes information regarding when all TWT agreements or TWT schedules between the non-AP MLD and the AP MLD are resumed, wherein the processor is further configured to resume, based on information regarding when all the TWT agreements or TWT schedules are resumed included in the second frame, all TWT agreements or TWT schedules between the non-AP MLD and the AP MLD.

One aspect of the present disclosure provides an access point (AP) multi-link device (MLD) in a wireless network. The AP MLD comprises a memory, and a processor coupled to the memory. The processor is configured to establish a first link between a first AP affiliated with the AP MLD and a first station (STA) affiliated with a non-AP MLD. The processor is configured to establish a second link between a second AP affiliated with the AP MLD and a second STA affiliated with the non-AP MLD. The processor is configured to establish a target-wake-time (TWT) agreement or a TWT schedule on the first link between the first AP and the first STA. The processor is configured to transmit, from the first AP to the first STA on the first link, a frame intended for the second STA operating on the second link, wherein the frame includes information regarding when the TWT agreement or the TWT schedule established on the second link is suspended.

In some embodiments, the frame indicates a starting service period (SP) from which the TWT agreement or the TWT schedule on the second link is suspended.

In some embodiments, the frame indicates a time after which the TWT agreement or the TWT schedule on the second link is suspended.

In some embodiments, the frame includes a TWT requesting STA media access control (MAC) address and a TWT responding STA MAC address, wherein the TWT requesting MAC address is a TWT requesting STA MAC address corresponding to the second link indicated in the frame and the TWT responding STA MAC address is a TWT responding STA MAC address corresponding to the second link indicated in the frame.

In some embodiments, the frame includes information regarding when all TWT agreements or TWT schedules between the AP MLD and the non-AP MLD are suspended, wherein the processor is further configured to suspend, based on the information regarding when all the TWT agreements or TWT schedules are suspended, all TWT agreements or TWT schedules between the AP MLD and the non-AP MLD.

In some embodiments, the processor is further configured to transmit, from the first AP to the first STA on the first link, a second frame intended for the second STA operating on the second link, wherein the second frame includes information regarding when the TWT agreement or the TWT schedule on the second link is resumed.

In some embodiments, the second frame includes information regarding when all TWT agreements or TWT schedules between the AP MLD and the non-AP MLD are resumed, wherein the processor is further configured to resume, based on information regarding when all the TWT agreements or TWT schedules are resumed included in the second frame, all TWT agreements or TWT schedules between the AP MLD and the non-AP MLD.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates multi-link discovery and setup in accordance with an embodiment.

FIG. 5A illustrates an example of a target-wake-time (TWT) element in accordance with an embodiment.

FIG. 5B illustrates service period (SP) timing relationships for a TWT schedule in accordance with an embodiment.

FIG. 6 illustrates a format of a TWT Information field in the TWT Information frame in accordance with an embodiment.

FIG. 7 illustrates a procedure for suspending a TWT agreement or TWT schedule in accordance with an embodiment.

FIG. 8 provides an example of TWT agreement or schedule suspension over one link for another link's TWT in accordance with an embodiment.

FIG. 9 illustrates an example of cross-link TWT suspension in accordance with an embodiment.

FIG. 10 illustrates an example cross-link TWT resumption in accordance with an embodiment.

FIG. 11 illustrates an example flow chart of a process by a non-AP MLD for communicating TWT information intended for a second link on a first link in accordance with an embodiment.

FIG. 12 illustrates an example flow chart of a process by a AP MLD for communicating TWT information intended for a second link on a first link in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

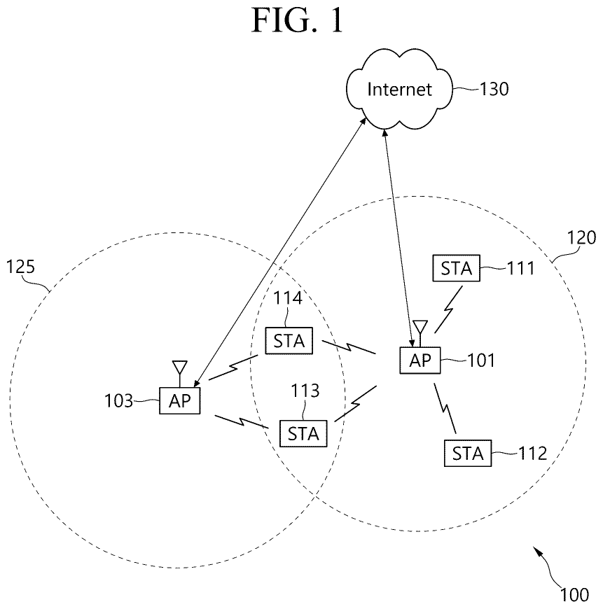

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage area 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

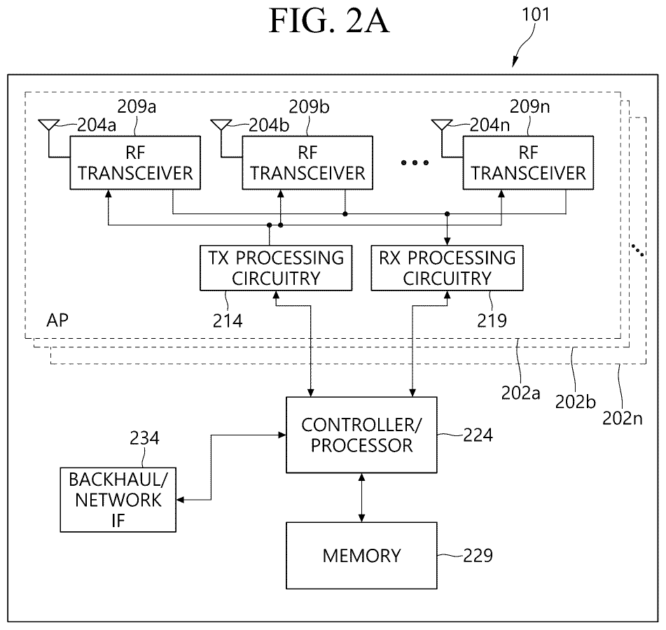

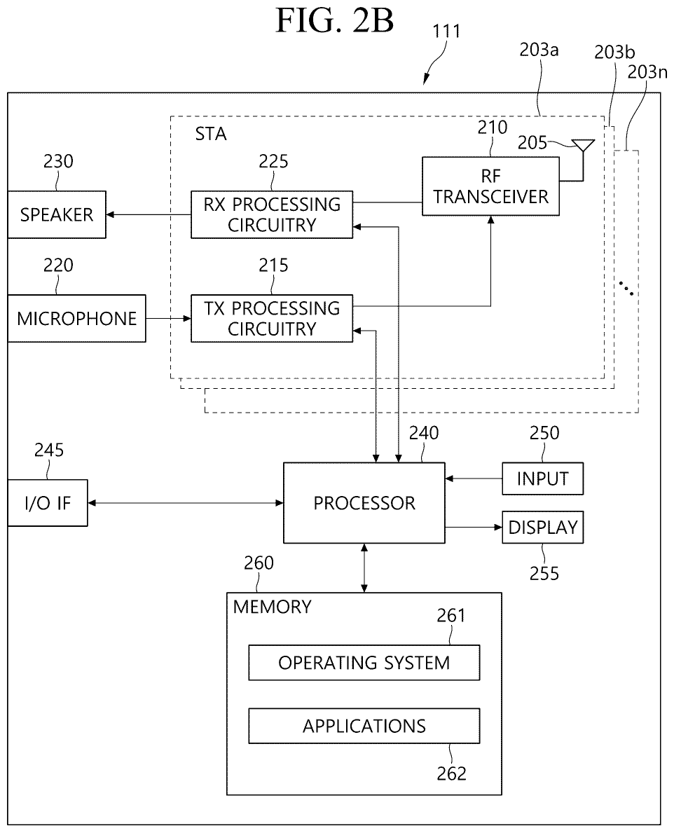

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

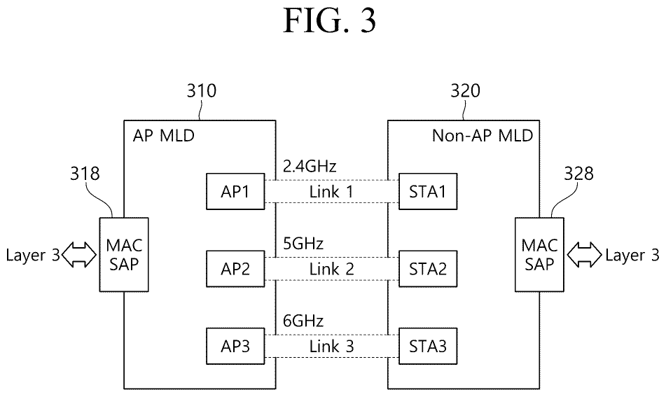

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

Multi-link operation may allow the discovery and setup of multiple links between an AP MLD and a non-AP MLD, where the discovery or the setup can take place over a single link.

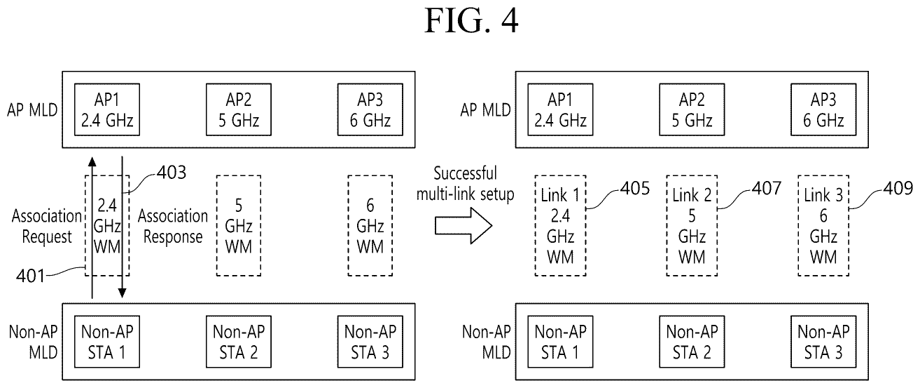

FIG. 4 illustrates multi-link discovery and setup in accordance with an embodiment. In particular, FIG. 4 illustrates an AP MLD communicating with a non-AP MLD. As illustrated, AP MLD is associated with AP1, AP2 and AP3, and non-AP MLD is associated with non-AP STA1, non-AP STA 2, and non-AP STA3. The non-AP MLD transmits an association request frame 401 to AP MLD. AP MLD then transmits an association response frame 403 to non-AP MLD. In FIG. 4, the association request frame 401 and the association response frame are transmitted over the 2.4 GHz link between the AP MLD and the non-AP MLD, where the setup is for establishing three links between the AP MLD and the non-AP MLD: one link on the 2.4 GHz band, a second link on the 5 GHz band, and a third link on the 6 GHz band. After the successful setup, the three links, including link 1 at 2.5 GHz 405, link 2 at 5 GHz 407, and link 3 at 6 GHz 409, are established between the AP MLD and the non-AP MLD.

Target wake time (TWT) is an important feature for power management in wireless networks, which was developed by IEEE 802.11ah and later adopted and modified into IEEE 802.11ax. With TWT operation, it suffices for an STA to only wake up at pre-scheduled time negotiated with another STA or AP in the network. In IEEE 802.11ax standards, two types of TWT operation are possible, including individual TWT operation and broadcast TWT operation. Individual TWT agreements can be established between two STAs or between an STA and an AP. On the other hand, with broadcast TWT operation, an AP can set up a shared TWT session for a group of STAs.

Restricted TWT operation is a feature introduced in IEEE 802.11be, which provides more protection for restricted TWT scheduled STAs in order to serve its latency sensitive application in a timely manner. Restricted TWT is based on a broadcast TWT mechanism, however, there are some key characteristics that makes restricted TWT operation an important feature for supporting low-latency applications in next generation WLAN systems.

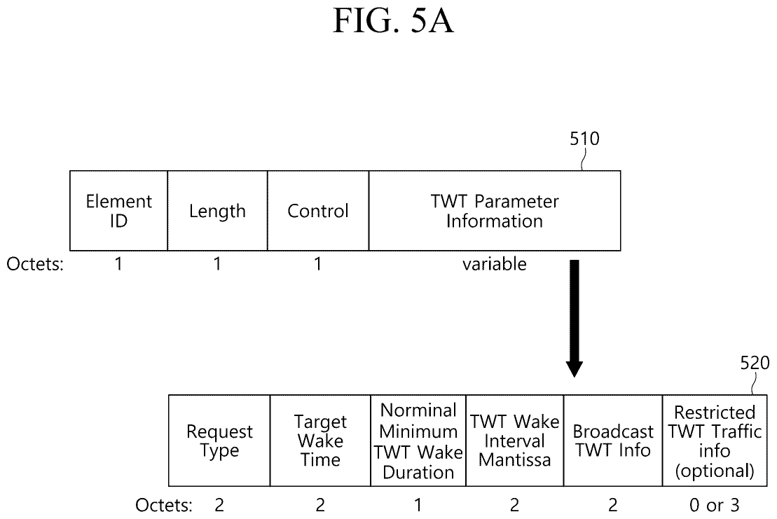

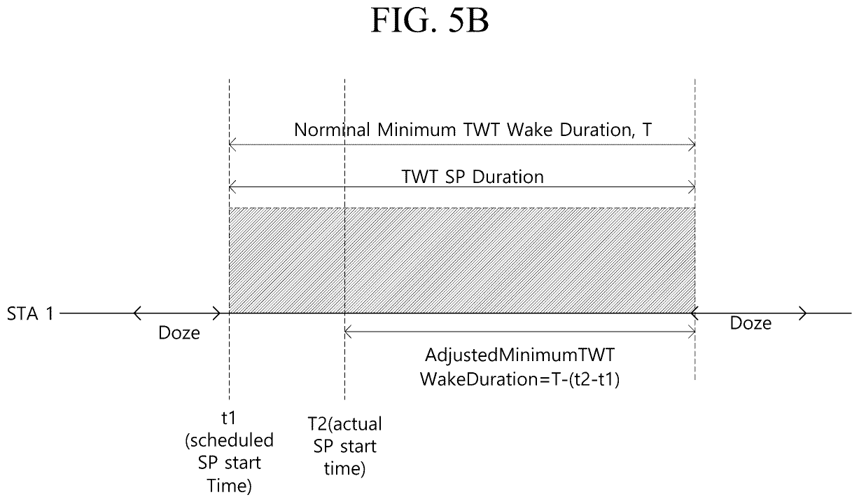

FIG. 5A illustrates an example of a TWT element in accordance with an embodiment. The TWT element may be applicable to IEEE 802.11be standard and any future amendments to the IEEE standard. The TWT element 510 may be included in a broadcast frame, such as a beacon frame, an association response frame, a reassociation response frame, or a probe response frame, transmitted by Aps affiliated with the AP MLD. In FIG. 5, the TWT element 510 may include a Broadcast TWT Parameter Set field which includes a Request Type field. Details about each field and subfields of the TWT element are further explained below. In FIG. 5A, the TWT element may include an Element identifier (ID) field, a length field, a Control field, and a TWT Parameter Information field. The Element ID field may include information to identify the TWT element. The Length field may indicate a length of the TWT element. The Control field may include control information.

The TWT Parameter Information field of the TWT element may include either a single Individual TWT Parameter Set field or one or more Broadcast TWT Parameter Set fields. In some implementations, if the Broadcast subfield of the Negotiation Type subfield in the Control field is 0, the TWT Parameter Information field includes the single Individual TWT Parameter Set field. Otherwise, the TWT Parameter Information field includes one or more Broadcast TWT Parameter Set fields. FIG. 5A describes the broadcast TWT as an example where the TWT Parameter Information field may include a Broadcast TWT Parameter Set fields.

The Broadcast TWT Parameter Set field 520 may include a Request Type field, a Target Wake Time field, a Nominal Minimum TWT Wake Duration field, a TWT Wake Interval Mantissa field, a Broadcast TWT Info (Information) field, and an optional Restricted TWT traffic Info field. The Request Type field may include information regarding a type of the request. The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake in order to complete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value. The Broadcast TWT Info field may include information on the Broadcast TWT. The Restricted TWT Traffic Info field (optional) may include information regarding the restricted TWT traffic.

FIG. 5B illustrates service period (SP) timing relationships for a TWT schedule in accordance with an embodiment. In particular, FIG. 5 illustrates different timing components pertaining to a TWT service period. As illustrated, STA1 is a TWT scheduled STA and AP1 (not shown in the figure) is its associated TWT scheduling AP. STA1 establishes a broadcast TWT schedule with AP1. In the Broadcast TWT Parameter Set field (e.g., as illustrated in FIG. 5A), t1 is the value of the target wake time indicated in the Target Wake Time field in the Broadcast TWT Parameter Set field of the TWT element. Hence, t1 is the time when STA1 should ideally be able to start frame exchanges with AP1. Starting from t1, the time duration the STA is required to remain awake is the value of the nominal wake time indicated in the Nominal Minimum TWT Wake Duration field in the Broadcast TW Parameter Set field (T). For various reasons, it may not be possible for STA1 to start frame exchanges with AP1 at the nominal SP start time, t1. An actual SP start time can be much later. As illustrated, actual SP start time is indicated as time t2. With the delayed actual SP start time, minimum wake duration for STA1 may also be adjusted and is indicated as the AdjustedMinimumTWTWakeDuration=T−(t2−t1).

For individual TWT, there are mechanisms to suspend/resume a particular individual TWT agreement followed by a TWT requesting STA while maintaining the other TWT agreements. There may be mechanisms to suspend or resume one or more (e.g., all) individual TWT agreements followed by the TWT requesting STA. For broadcast TWT, there may be mechanisms to suspend or resume one or more (e.g., all) TWT schedules followed by a TWT scheduled STA.

A flexible TWT is a TWT the value of which may or may not be selected from the available set of TWT values as per a TWT negotiation. A flexible TWT can be a positive value regardless of the set of values negotiated for TWTs.

In some embodiments, a TWT information frame is sent by a STA to request or deliver information about a TWT. In some embodiments, the TWT information frame is transmitted by a STA of a TWT agreement or TWT schedule, or is transmitted by a STA to its peer STA. A format of the TWT Information frame in accordance with an embodiment is shown in Table 1.

TABLE 1

| Order | Information |
|---|---|
| 1 | Category |
| 2 | Unprotected S1G Action |
| 3 | TWT Information field |

The category field may include category information of the element. The unprotected S1G action field may include action information. The TWT information field may include TWT information.

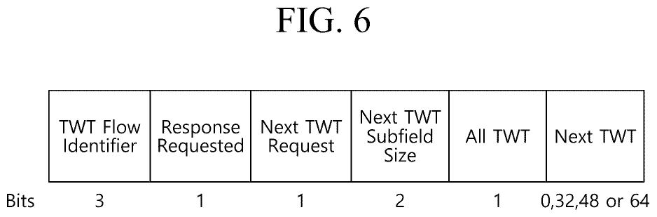

FIG. 6 illustrates a format of a TWT Information field in the TWT Information frame in accordance with an embodiment. The TWT information field may include a TWT flow identifier field, a response requested field, a next TWT request field, a next TWT subfield size, an all TWT field, and a next TWT field. The TWT flow identifier field may include a TWT flow identifier for which TWT information is requested or being provided. The response requested field may indicate whether the transmitter of the frame that includes the TWT information field is requesting a TWT information frame to be transmitted in response to this frame. The next TWT request field may include information on a next TWT, including a time when a next TWT may be resumed and/or suspended. The next TWT subfield size field may include size information of a next TWT. The All TWT field may include information on all TWT agreements that may be resumed and/or suspended, and may be set to 1 to indicate that the TWT information frame reschedules all TWTs, otherwise it may be set to 0. The next TWT field may indicate a time at which a TWT agreement or schedule may be resumed and/or suspended.

In some embodiments, a STA affiliated with a non-AP MLD or an AP affiliated with an AP MLD operating on a link can suspend or resume a TWT agreement or a TWT schedule that is established over another link between the same AP MLD and the non-AP MLD.

In some embodiments, when a non-AP MLD is associated with an AP MLD. A first STA affiliated with the non-AP MLD and operating on a first link between the AP MLD and the non-AP MLD can send a TWT Information frame to a first AP affiliated with the AP MLD and operating on the first link. The intended recipient of the TWT Information frame may be a second AP affiliated with the same AP MLD and operating on a second link between the same AP MLD and the non-AP MLD. In some embodiments, in order to make such an indication, the non-AP MLD can include an MLO Link Information element in the same MMPDU that includes the TWT Information frame. The Link ID Bitmap field in the MLO Link Information element can indicate the link for which the TWT Information frame is intended. This procedure can be applicable for individual TWT agreements and/or broadcast TWT schedules.

In some embodiments, when a non-AP MLD is associated with an AP MLD, a first AP affiliated with the AP MLD and operating on a first link between the AP MLD and the non-AP MLD can send a TWT Information frame to a first non-AP STA affiliated with the non-AP MLD and operating on the first link. The intended recipient of the TWT Information frame may be a second non-AP STA affiliated with the same non-AP MLD and operating on a second link between the same AP MLD and the non-AP MLD. In some embodiments, in order to make such an indication, the AP MLD can include an MLO Link Information element in the same MMPDU that includes the TWT Information frame. The Link ID Bitmap field in the MLO Link Information element can indicate the link for which the TWT Information frame is intended. This procedure can be applicable for individual TWT agreements and/or broadcast TWT schedules.

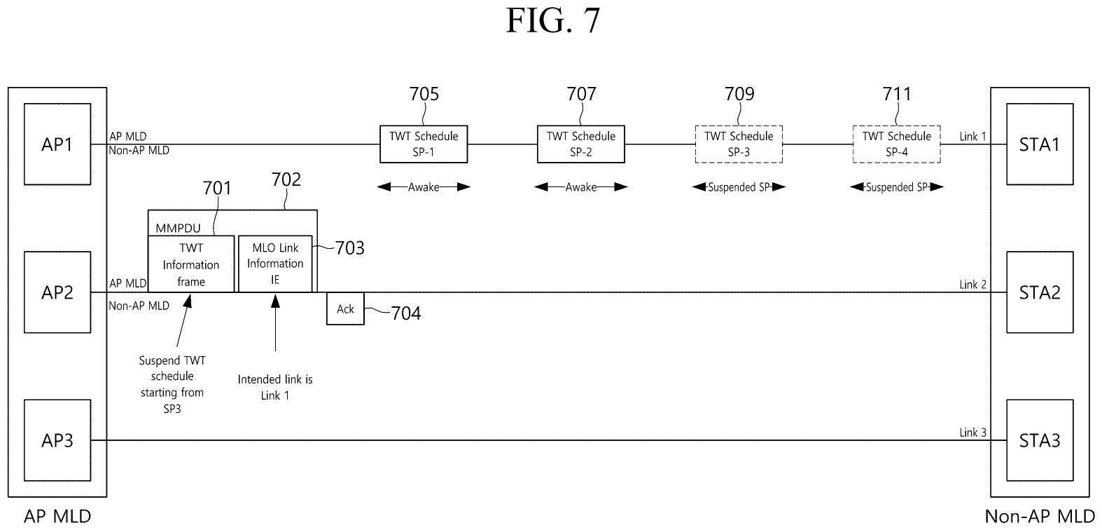

FIG. 7 illustrates a procedure for suspending a TWT schedule in accordance with an embodiment. In particular, FIG. 7 illustrates a suspension of a TWT schedule on one link by transmitting a TWT Information frame on a different link. As illustrated, AP1, AP2, and AP3 are affiliated with AP MLD and STA1, STA2, and STA3 are affiliated with non-AP MLD. AP1 is associated with STA 1 and has an established link, Link 1, with STA1. AP2 is associated with STA2 and has an established link, Link 2, with STA 2. AP3 is associated with STA3 and has an established link, Link 3, with STA3. A TWT Service Period (SP) is established on Link 1 between AP1 and STA1.

As illustrated, a MAC Management Protocol Data Unit (MMPDU) 702 that includes the TWT Information frame 701 and MLO Link Information Element 703 is transmitted by AP2 to STA2 over Link 2 between the AP MLD and a non-AP MLD. The TWT Information frame 701 is intended for a TWT schedule on Link 1. In some embodiments, the transmitted MMPDU 702 by AP2 may also include an MLO Link Information element 703 together with the TWT Information frame 701. The MLO Link Information element 703 indicates in the Link ID Bitmap subfield Link 1. In some implementations, the bit position corresponding to Link 1 in the Link ID Bitmap is set to 1 to indicate that the TWT Information frame is intended for a TWT schedule on Link 1. The TWT Information frame 701 indicates that starting from SP3, the TWT schedule would be suspended. The STA2 affiliated with non-AP MLD transmits an acknowledgement frame (ACK) 704 to AP2 affiliated with AP MLD on Link 2. Accordingly, as illustrated in FIG. 7, TWT schedule SP-1 705 and TWT schedule SP-2 707 are indicated as awake and thus able to receive and/or transmit data, while the TWT schedule SP-3 709 and TWT schedule SP-4 711 are indicated as suspended.

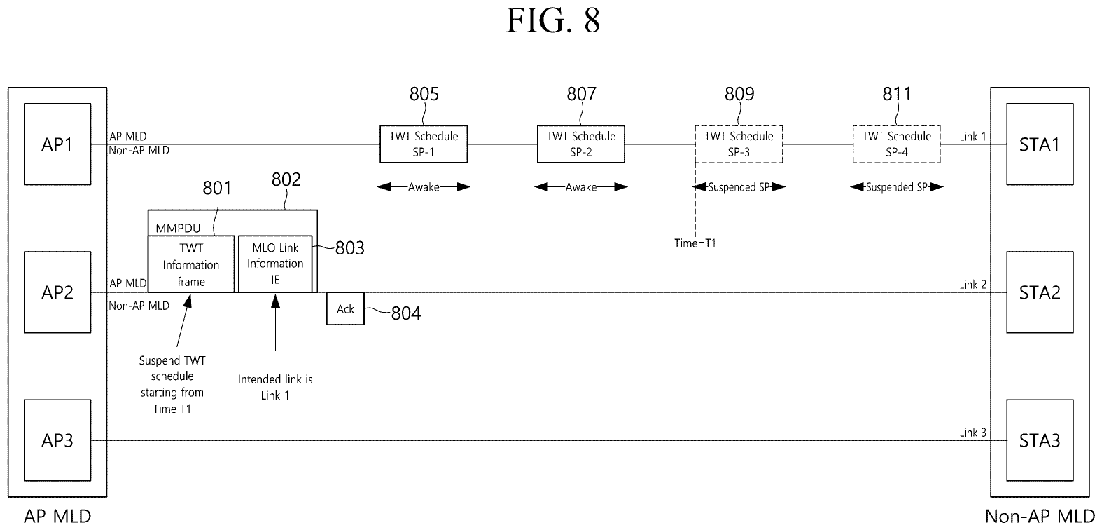

FIG. 8 provides an example of TWT schedule suspension over one link for another link's TWT in accordance with an embodiment. As illustrated, a time instant is indicated in the TWT Information frame 801. This time instant may indicate a time after which the TWT SPs corresponding to a TWT schedule would be suspended. In particular, FIG. 8 illustrates AP MLD communicating with non-AP MLD. As illustrated, AP1, AP2, and AP3 are affiliated with AP MLD and STA1, STA2, and STA3 are affiliated with non-AP MLD. AP1 is associated with STA1 and has an established link, Link 1, with STA1. AP2 is associated with STA2 and has an established link, Link 2, with STA2. AP3 is associated with STA3 and has an established link, Link 3, with STA3. A TWT SP is established on Link 1 between AP1 and STA1.

As illustrated, a MMPDU 802 that includes the TWT Information frame 801 and MLO Link Information Element 803 is transmitted by AP2 to STA2 over Link 2 between the AP MLD and the non-AP MLD. The TWT Information frame is intended for a TWT schedule on Link 1. In some embodiments, the transmitted MMPDU 802 may also include an MLO Link Information element 803 together with the TWT Information frame 801. The MLO Link Information element 803 indicates in the Link ID Bitmap subfield Link 1. In some implementations, the bit position corresponding to Link 1 in the Link ID Bitmap is set to 1 to indicate that the TWT Information frame is intended for a TWT schedule on Link 1. The TWT Information frame 801 indicates that starting from a time T1 (e.g., SP3) the TWT schedule would be suspended. The STA2 affiliated with non-AP MLD transmits an acknowledgement frame (ACK) 804 to AP2 affiliated with AP MLD on Link 2. Accordingly, as illustrated, TWT schedule SP-1 805 and TWT schedule SP-2 807 are indicated as awake and thus able to receive and/or transmit data, while, starting from time T1, TWT schedule SP-3 809 and TWT schedule SP-4 811 are indicated as suspended.

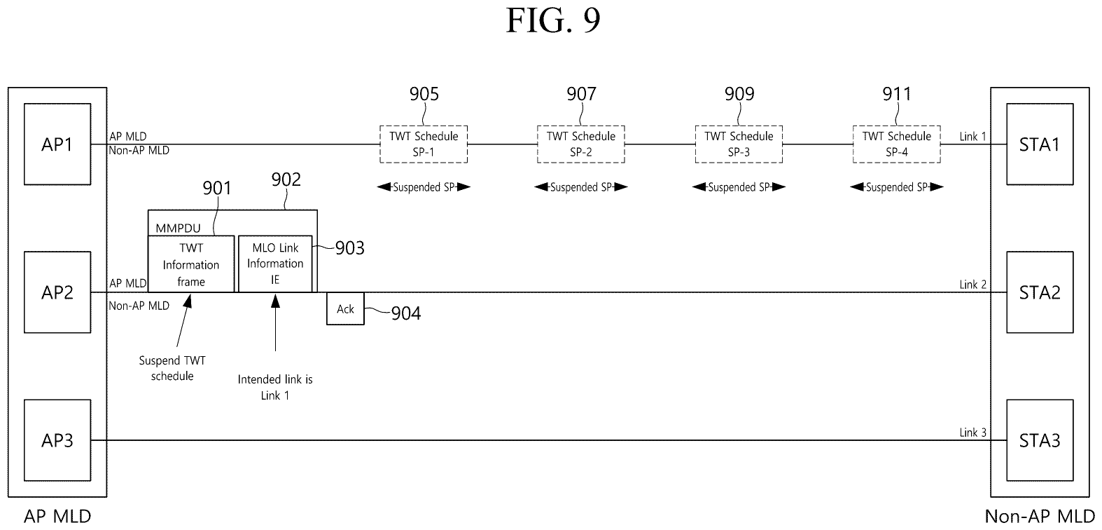

FIG. 9 illustrates an example of cross-link TWT suspension in accordance with an embodiment. In FIG. 9, after receiving the TWT Information frame on Link 2, the TWT SPs corresponding to a TWT schedule on Link 1 are suspended. In particular, FIG. 9 illustrates AP MLD communicating with non-AP MLD. As illustrated, AP1, AP2, and AP3 are affiliated with AP MLD and STA1, STA2, and STA3 are affiliated with non-AP MLD. AP1 is associated with STA1 and has an established link, Link 1, with STA1. AP2 is associated with STA2 and has an established link, Link 2, with STA2. AP3 is associated with STA3 and has an established link, Link 3, with STA3. A TWT Service Period (SP) is established on Link 1 between AP1 and STA1.

As illustrated, the MMPDU 902 that includes the TWT Information frame 901 and MLO Link Information Element 903 is transmitted by AP2 over Link 2 to STA2. The MLO Link Information element 903 indicates that the intended link is Link 1. In some implementations, the bit position corresponding to Link 1 in the Link ID Bitmap is set to 1 to indicate that the TWT Information frame is intended for a TWT schedule on Link 1. The TWT Information frame 901 indicates to suspend the TWT schedule. In particular, after receiving the TWT Information frame 901 on Link 2, the TWT SPs corresponding to the TWT schedule on Link 1 are suspended. The STA2 affiliated with non-AP MLD transmits an acknowledgement frame (ACK) 904 to AP2 affiliated with AP MLD on Link 2. Accordingly, as illustrated, TWT schedule SP-1 905, TWT schedule SP-2 907, TWT schedule SP-3 909 and TWT schedule SP-4 911 are indicated as suspended.

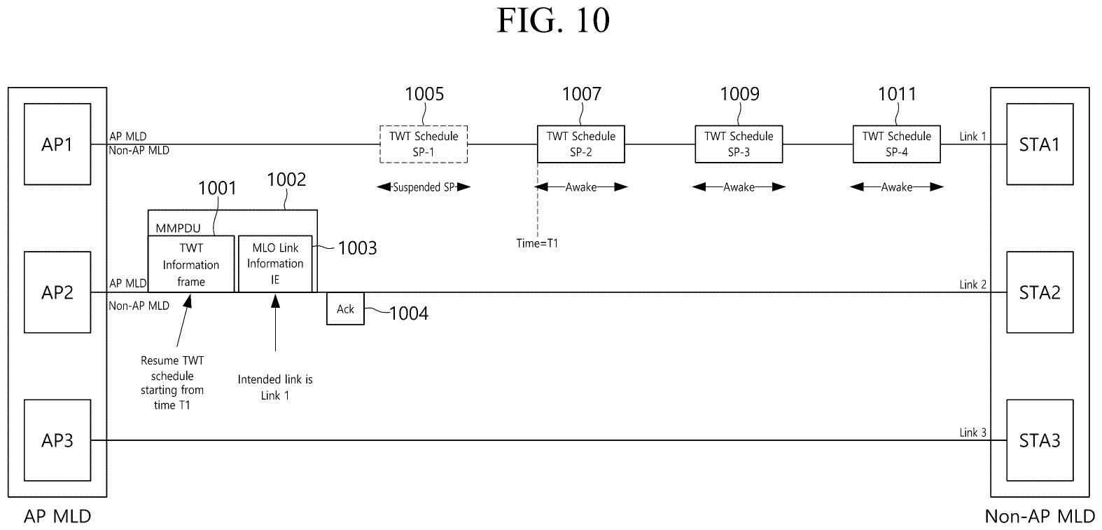

FIG. 10 illustrates an example cross-link TWT resumption in accordance with an embodiment. In particular, FIG. 10 illustrates AP MLD communicating with non-AP MLD. As illustrated, AP1, AP2, and AP3 are affiliated with AP MLD and STA1, STA2, and STA3 are affiliated with non-AP MLD. AP1 is associated with STA1 and has an established link, Link 1, with STA1. AP2 is associated with STA2 and has an established link, Link 2, with STA2. AP3 is associated with STA3 and has an established link, Link 3, with STA3. A TWT Service Period (SP) is established on Link 1 between AP1 and STA1.

AP2 transmits a MMPDU 1002 that includes a TWT Information frame 1001 and an MLO Link Information Element 1003 over Link 2 to STA2 affiliated with non-AP MLD. The TWT Information frame 1001 is intended for a TWT schedule on Link 1. In some embodiments, the MMPDU 1002 transmitted from STA2 may also include an MLO Link Information element 1003 together with the TWT Information frame 1001. The MLO Link Information element 1003 indicates that the intended link is Link 1. In some implementations, the bit position corresponding to Link 1 in the Link ID Bitmap is set to 1 to indicate that the TWT Information frame is intended for a TWT schedule on Link 1. The TWT Information frame 1001 may indicate that the corresponding TWT schedule would resume starting from time T1 (e.g., the Next TWT subfield in the TWT Information field can be set to T1). The STA2 affiliated with non-AP MLD transmits an acknowledgement frame (ACK) 1004 to AP2 affiliated with AP MLD on Link 2. Accordingly, as illustrated TWT schedule SP-1 1005 is indicated as suspended, and after time T1, the TWT schedule SP-2 1007, TWT schedule SP-3 1009 and TWT schedule SP-4 1011 are indicated as awake and thus able to receive and/or transmit data.

In some embodiments, when a TWT Information frame with the MLO Link Information element is successfully transmitted or received through the affiliated STAs between two MLDs, the TWT agreement corresponding to the TWT Flow Identifier field, TWT requesting STA MAC address and TWT responding STA MAC address of the TWT Information frame, can be suspended. In particular, the TWT agreement may be suspended where the TWT requesting STA MAC address of the TWT Information frame is the TWT requesting STA MAC address corresponding to the link indicated in the Link ID Bitmap subfield of the MLO Link Information element, and the TWT responding STA MAC address of the TWT Information frame is the TWT responding STA MAC address corresponding to the link indicated in the Link ID Bitmap subfield of the MLO Link Information element.

In some embodiments, when a TWT Information frame with the MLO Link Information element is successfully transmitted or received through the affiliated STAs between two MLDs, the TWT agreement corresponding to the TWT Flow Identifier field, TWT requesting STA MAC address and TWT responding STA MAC address of the TWT Information frame, can be resumed (e.g., resumed from the time as indicated in the Next TWT subfield). In particular, the TWT agreement can be resumed where the TWT requesting STA MAC address of the TWT Information frame is the TWT requesting STA MAC address corresponding to the link indicated in the Link ID Bitmap subfield of the MLO Link Information element, and the TWT responding STA MAC address of the TWT Information frame is the TWT responding STA MAC address corresponding to the link indicated in the Link ID Bitmap subfield of the MLO Link Information element.

In some embodiments, when a TWT Information frame with the MLO Link Information element is successfully transmitted or received through the affiliated STAs between two MLDs, if the All TWT field in the TWT Information field is set to 1, then all the TWT agreements between the STAs identified by TWT requesting STA MAC address and TWT responding STA MAC address of the TWT Information frame, can be suspended or can be resumed. In particular, the TWT agreements may be suspended or resumed where the TWT requesting STA MAC address of the TWT Information frame is the TWT requesting STA MAC address corresponding to the link indicated in the Link ID Bitmap subfield of the MLO Link Information element, and the TWT responding STA MAC address of the TWT Information frame is the TWT responding STA MAC address corresponding to the link indicated in the Link ID Bitmap subfield of the MLO Link Information element.

In some embodiments, when a TWT Information frame with the MLO Link Information element is successfully transmitted or received through the affiliated STAs between two MLDs, a broadcast TWT schedule or a restricted TWT schedule between a TWT scheduling AP affiliated with the AP MLD and a TWT scheduled STA affiliated with the non-AP MLD can be suspended or can be resumed (e.g. resumed at the time indicated in the Next TWT subfield of the TWT Information frame). In particular, the broadcast TWT schedule or the restricted TWT schedule can be suspended or resumed, where the TWT scheduling AP MAC address of the TWT Information frame is the TWT scheduling AP's MAC address corresponding to the link indicated in the Link ID Bitmap subfield of the MLO Link Information element, and the TWT scheduled STA MAC address of the TWT Information frame is the TWT scheduled STA MAC address corresponding to the link indicated in the Link ID Bitmap subfield of the MLO Link Information element.

In some embodiments, the TWT Information frame action field may include an MLO Link Information element. In some embodiments, the format of the TWT Information frame is shown in Table 2.

TABLE 2

| Order | Information |
|---|---|
| 1 | Category |
| 2 | Unprotected S1G Action |
| 3 | TWT Information field |
| 4 | MLO Link Information Element |

The category field may include category information of the element. The unprotected SIG action field may include action information. The TWT information field may include TWT information. The MLO link information element may include link information on the multi-link operation that may be suspended or resumed.

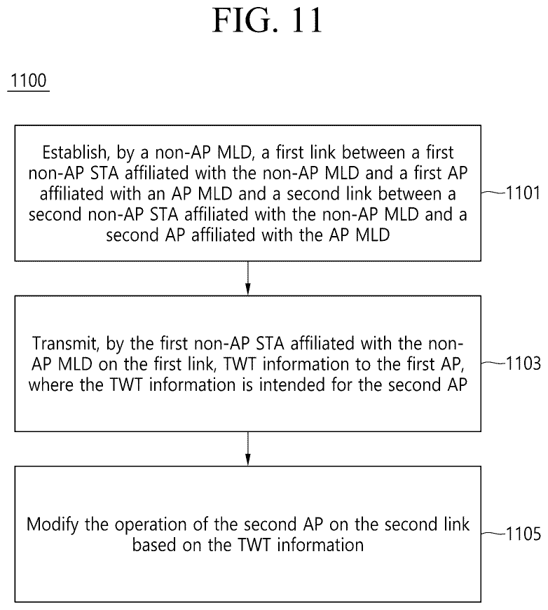

FIG. 11 illustrates an example process, by a non-AP MLD, of transmitting TWT information on a first link where the TWT information is intended for a second link between the non-AP MLD and a AP MLD. Although one or more operations are described or shown in particular sequential order, in other embodiments the operations may be rearranged in a different order, which may include performance of multiple operations in at least partially overlapping time periods. The flowchart depicted in FIG. 11 illustrates operations performed in a non-AP MLD, such as non-AP MLD illustrated in FIG. 3.

The process 1100 may begin in operation 1101. In operation 1101, the process 1100 establishes, by a non-AP MLD, a first link between a first non-AP STA affiliated with the non-AP MLD and a first AP affiliated with the AP MLD and a second link between a second non-AP STA affiliated with the non-AP MLD and a second AP affiliated with the AP MLD.

In operation 1103, the process transmits by the first non-AP STA affiliated with the non-AP MLD on the first link, TWT information intended for the second AP. The TWT information can be to suspend or resume a TWT agreement or a TWT schedule associated with the second AP operating on the second link. The TWT information may include a start time or a service period upon which the TWT agreement or TWT schedule should be suspended or resumed.

In operation 1105, the process modifies the operation of the second AP on the second link, including suspending or resuming the TWT agreement or TWT schedule associated with the second AP on the second link.

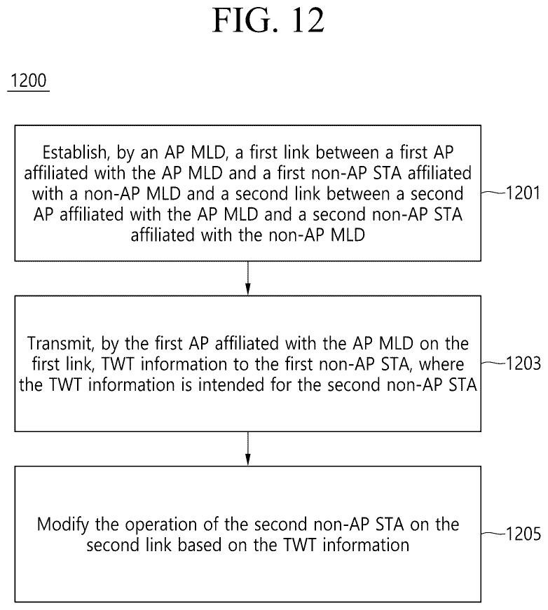

FIG. 12 illustrates an example process, by a AP MLD, of transmitting TWT information on a first link where the TWT information is intended for a second link between the non-AP MLD and a AP MLD. Although one or more operations are described or shown in particular sequential order, in other embodiments the operations may be rearranged in a different order, which may include performance of multiple operations in at least partially overlapping time periods. The flowchart depicted in FIG. 12 illustrates operations performed in a AP MLD, such as AP MLD illustrated in FIG. 3.

The process 1200 may begin in operation 1201. In operation 1201, the process 1100 establishes, by AP MLD, a first link between a first AP affiliated with the AP MLD and a first non-AP STA affiliated with the non-AP MLD and a second link between a second AP affiliated with the AP MLD and a second non-AP STA affiliated with the non-AP MLD.

In operation 1203, the process transmits by the first AP affiliated with the AP MLD on the first link, TWT information intended for the second non-AP STA. The TWT information can be to suspend or resume a TWT agreement or a TWT schedule associated with the second non-AP STA operating on the second link. The TWT information may include a start time or a service period upon which the TWT agreement or TWT schedule should be suspended or resumed.

In operation 1205, the process modifies the operation of the second non-AP STA on the second link, including suspending or resuming the TWT agreement or TWT schedule associated with the second non-AP STA on the second link.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A non-access point (AP) multi-link device (MLD) in a wireless network, the non-AP MLD comprising:
a memory; and
a processor coupled to the memory, the processor configured to:
establish a first link between a first station (STA) affiliated with the non-AP MLD and a first AP affiliated with an AP MLD;
establish a second link between a second STA affiliated with the non-AP MLD and a second AP affiliated with the AP MLD;
establish a target-wake-time (TWT) agreement or a TWT schedule on the first link between the first STA and the first AP; and
transmit, from the first STA to the first AP on the first link, a frame intended for the second AP operating on the second link, wherein the frame includes information regarding when the TWT agreement or the TWT schedule established on the second link is suspended.

2. The non-AP MLD of claim 1, wherein the frame indicates a starting service period (SP) from which the TWT agreement or the TWT schedule on the second link is suspended.

3. The non-AP MLD of claim 1, wherein the frame indicates a time after which the TWT agreement or the TWT schedule on the second link is suspended.

4. The non-AP MLD of claim 1, wherein the frame includes a TWT requesting STA media access control (MAC) address and a TWT responding STA MAC address, wherein the TWT requesting MAC address is a TWT requesting STA MAC address corresponding to the second link indicated in the frame and the TWT responding STA MAC address is a TWT responding STA MAC address corresponding to the second link indicated in the frame.

5. The non-AP MLD of claim 1, wherein the frame includes information regarding when all TWT agreements or TWT schedules between the non-AP MLD and the AP MLD are suspended, wherein the processor is further configured to:
suspend, based on the information regarding when all the TWT agreements or TWT schedules are suspended, all TWT agreements or TWT schedules between the non-AP MLD and the AP MLD.

6. The non-AP MLD of claim 1, wherein the processor is further configured to:
transmit, from the first STA to the first AP on the first link, a second frame intended for the second AP operating on the second link, wherein the second frame includes information regarding when the TWT agreement or the TWT schedule on the second link is resumed.

7. The non-AP MLD of claim 6, wherein the second frame includes information regarding when all TWT agreements or TWT schedules between the non-AP MLD and the AP MLD are resumed, wherein the processor is further configured to:
resume, based on information regarding when all the TWT agreements or TWT schedules are resumed included in the second frame, all TWT agreements or TWT schedules between the non-AP MLD and the AP MLD.

8. An access point (AP) multi-link device (MLD) in a wireless network, the AP MLD comprising:
a memory; and
a processor coupled to the memory, the processor configured to:
establish a first link between a first AP affiliated with the AP MLD and a first station (STA) affiliated with a non-AP MLD;
establish a second link between a second AP affiliated with the AP MLD and a second STA affiliated with the non-AP MLD;
establish a target-wake-time (TWT) agreement or a TWT schedule on the first link between the first AP and the first STA; and
transmit, from the first AP to the first STA on the first link, a frame intended for the second STA operating on the second link, wherein the frame includes information regarding when the TWT agreement or the TWT schedule established on the second link is suspended.

9. The AP MLD of claim 8, wherein the frame indicates a starting service period (SP) from which the TWT agreement or the TWT schedule on the second link is suspended.

10. The AP MLD of claim 8, wherein the frame indicates a time after which the TWT agreement or the TWT schedule on the second link is suspended.

11. The AP MLD of claim 8, wherein the frame includes a TWT requesting STA media access control (MAC) address and a TWT responding STA MAC address, wherein the TWT requesting MAC address is a TWT requesting STA MAC address corresponding to the second link indicated in the frame and the TWT responding STA MAC address is a TWT responding STA MAC address corresponding to the second link indicated in the frame.

12. The AP MLD of claim 8, wherein the frame includes information regarding when all TWT agreements or TWT schedules between the AP MLD and the non-AP MLD are suspended, wherein the processor is further configured to:
suspend, based on the information regarding when all the TWT agreements or TWT schedules are suspended, all TWT agreements or TWT schedules between the AP MLD and the non-AP MLD.

13. The AP MLD of claim 8, wherein the processor is further configured to:
transmit, from the first AP to the first STA on the first link, a second frame intended for the second STA operating on the second link, wherein the second frame includes information regarding when the TWT agreement or the TWT schedule on the second link is resumed.

14. The AP MLD of claim 13, wherein the second frame includes information regarding when all TWT agreements or TWT schedules between the AP MLD and the non-AP MLD are resumed, wherein the processor is further configured to:
resume, based on information regarding when all the TWT agreements or TWT schedules are resumed included in the second frame, all TWT agreements or TWT schedules between the AP MLD and the non-AP MLD.

15. A computer-implemented method for communication by a non-access point (AP) multi-link device (MLD) in a wireless network, the method comprising:
establishing a first link between a first station (STA) affiliated with the non-AP MLD and a first AP affiliated with an AP MLD;
establishing a second link between a second STA affiliated with the non-AP MLD and a second AP affiliated with the AP MLD;
establishing a target-wake-time (TWT) agreement or a TWT schedule on the first link between the first STA and the first AP; and
transmitting, from the first STA to the first AP on the first link, a frame intended for the second AP operating on the second link, wherein the frame includes information regarding when the TWT agreement or the TWT schedule established on the second link is suspended.

16. The computer-implemented method of claim 15, wherein the frame indicates a starting service period (SP) from which the TWT agreement or the TWT schedule on the second link is suspended.

17. The computer-implemented method of claim 15, wherein the frame indicates a time after which the TWT agreement or the TWT schedule on the second link is suspended.

18. The computer-implemented method of claim 15, wherein the frame includes a TWT requesting STA media access control (MAC) address and a TWT responding STA MAC address, wherein the TWT requesting MAC address is a TWT requesting STA MAC address corresponding to the second link indicated in the frame and the TWT responding STA MAC address is a TWT responding STA MAC address corresponding to the second link indicated in the frame.

19. The computer-implemented method of claim 15, wherein the frame includes information regarding when all TWT agreements or TWT schedules between the non-AP MLD and the AP MLD are suspended, wherein the method further comprises:
suspending, based on the information regarding when all the TWT agreements or TWT schedules are suspended, all TWT agreements or TWT schedules between the non-AP MLD and the AP MLD.

20. The computer-implemented method of claim 15, further comprising:
transmitting, from the first STA to the first AP on the first link, a second frame intended for the second AP operating on the second link, wherein the second frame includes information regarding when the TWT agreement or the TWT schedule on the second link is resumed.
